(19) United States
(12) Patent Application Publication
(10) Pub. No.: US 2008/0202491 A1
(43) Pub. Date: Aug. 28, 2008

(54) Air Collecting Device And Exhaust Air Box, In Particular Usable In Said Device

(76) Inventor: Jurgen Eberhard, Benningen (DE)

Correspondence Address: MICHAUD-DUFFY GROUP LLP, 306 INDUSTRIAL PARK ROAD, SUITE 206, MIDDLETOWN, CT, 06457, US

(21) Appl. No.: 11/661,589

(22) PCT Filed: Aug. 30, 2005
(86) PCT No.: PCT/EP05/09345

§ 371 Date: May 1, 2008

(30) Foreign Application Priority Data
Aug. 31, 2004 (DE) 10 2004 042 158.7

(51) Int. Cl. F24C 15/20; B01D 53/22; F24F 7/00

(52) U.S. Cl. 126/299 D; 96/12; 454/65

(57) ABSTRACT

The invention relates to an air holding device comprising a channel system raised from a suction opening disposed at a height of a workstation generating dirty air or vapours and leading to at least one outlet opening. An exhausting fan is placed between a prefilter and at least one odour filter. The channel system is embodied in the form of an exhaust air box disposed downstream of the exhaust fan. The lateral surface of the exhaust air box comprises an air inlet which is connected to the downstream side of the exhausting fan. The other lateral surfaces are selectively provided with air outlet openings covered respectively with an odour filter having an adjustable air resistance. Said odour filter preferably consists of a foam material coated with active carbon and the air resistance thereof is selectable according the thickness and/or porosity of the foam material.

### FIELD OF THE INVENTION

The invention relates to an air collecting device and an exhaust air box.

### BACKGROUND OF THE INVENTION

In principle, such an air collecting device can be installed in all kinds of workstations wherein the air emits odours and, depending on the circumstances, is additionally loaded with fat or particles, for example at workstations in kitchens, food distribution equipment, workshops, laboratories or even anatomic or legal medicine institutes.

An example for a kitchen workstation is a food cooking apparatus as known from EP 0 915 299 B1 which is provided with such an air collecting device designed as a vapour collecting device and which is integrated in a cooking and sales counter, and is described further down below in greater detail.

According to an “Instruction Leaflet for large-scale kitchen equipment with an integrated vapour collecting device that is not connected to the ventilation and air conditioning system”, listed as No. F5-2N056, published in July 2004 by the Industrial Association for Domestic, Heating and Kitchen Technology (registered association), integrated vapour collecting systems which are installed over thermal large-scale kitchen equipment or over thermal equipment in the dispensing zone are not connected to the kitchen ventilation system. An integrated vapour collecting system is not a ventilation and air conditioning system (RLT-system) in the sense of VDI 2052 “Ventilation and Air Conditioning Systems for Kitchens” and it cannot replace this either. According to the Instruction Leaflet, integrated vapour collecting systems positioned over large-scale kitchen equipment and the vapour flow originating at that location and equipment where such integrated vapour collecting devices can be used, are all thermal large-scale kitchen equipment and thermal equipment in food distribution equipment.

According to this Instruction Leaflet, a horizontal and induction-low air duct must be provided for outlet air openings near the floor. In conjunction with VDI 2052, this provision states that the mean air velocity downstream of the outlet air openings should not be greater than 0.6 m/s because, as from this value upwards namely, draft air can be spoken of which causes dust to rise, and results in freezing conditions for persons working at the thermal equipment as well as causing other reductions in comfort for these persons as well.

The health-technical requirements for the comfort and well-being of persons in the working area of spaces involving different degrees of strenuous physical activity are defined in DIN 1946, Part 2, January 1994. Accordingly, RLT-systems for spaces in which persons stay should provide a comfortable room climate and a health-compatible ambient air. In FIG. 2 on page 3, DIN 1946 states values of mean air velocities as a function of temperature and turbulence degree of the air in the comfortable level zone. Accordingly, and with a turbulence degree of up to a minimum of 5% and an air temperature of 20 to 27° C., the mean air velocity should not exceed a value of approx. 0.43 m/s. From FIG. 2, the already above-mentioned value of the mean air velocity of 0.6 m/s can be extrapolated for 28° C. and at a turbulence degree of 5%. As shown above, however, an integrated air or vapour collecting device is not an RLT-system but it is used in combination with such RLT-systems and should generate exhaust air, the air velocity of which does not exceed at least the aforementioned maximum value of 0.6 m/s in order to work in the same way as the RLT-system in the comfort level range. Otherwise the case would arise where persons working in the dwelling area of spaces are not affected in their personal comfort by the RLT-system but rather by the air or vapour collecting device. Up to the present, a horizontal and induction-low air duct did not have to be considered for air or vapour collecting systems. However, there is now a Directive in effect since the year 2004 which stipulates such an air duct at least for vapour collecting systems, as shown by the Instruction Leaflet mentioned above.

For the known food cooking apparatus from the EP 0 915 299 B1 as already mentioned above, the suction opening comprises suction slots which are arranged on three sides of a cooking apparatus, at that location where the vapour originates. As a filtration device, a filter unit is arranged below the cooking apparatus in such a way that the suction fan, also located below the cooking apparatus, suctions off the exhaust air from the cooking apparatus through corresponding ducts and then suctions the exhaust air all the way through the filter unit, whereupon the exhaust air is conveyed through the suction fan to the outside.

Preferably, the filter unit consists of two essentially identical units which are arranged on both sides of the fan. Each of these two identical units consists of several panels in an essentially vertical arrangement and which have different filtration characteristics, for example a fleece for catching water vapour and moisture followed by a panel made of filter material which has the function of a fat filter and, after these, one or several further filter panels containing active carbon as filter material in order to filtrate volatile and odour-forming substances out of the exhaust air. The outlet air opening is located in the bottom of a casing, in which the vapour collecting device is accommodated, and conducts the exhaust air downwards onto the floor of a space where the food cooking apparatus is positioned. If the space in this case is a closed-off room, the exhaust air is returned to the room as circulating air. The suction fan is directly connected to the outlet air opening. As the vapour at the cooking apparatus has to be suctioned off on three sides and has to be suctioned all the way through two filter units, between which the suction fan is located, the suction fan must necessarily have a higher delivery capacity. The unavoidable result is that the value of the mean air velocity at the outlet air opening located near floor level is substantially higher than the above-mentioned value of 0.6 m/s.

From the EP 1 194 721 B1, which goes back to the applicant, an air suctioning device for a workstation is known, particularly a workstation where food is heated, which is equivalent to the air collecting device according to the preamble of claim 1. This known air suctioning device differs from the vapour collecting device of the food cooking apparatus according to EP 0 915 299 B1 particularly in such a way that the air loaded with vapour is suctioned off only by way of one single suction opening on one side of a workstation, namely a food cooking apparatus, and that, opposite the suction opening, a blowing air slot is located through which the air is blown over the workstation in the direction towards the suction opening for the purpose of producing an air film above the workstation. The fan which is not located behind all filters with this known air suctioning device, as in the case of the food cooking apparatus according to EP 0 915 299 B1, but between a pre-filter designed as a fat filter and the odour filter, supplies the air into a space leading to the blowing air slot, where in the said space a higher pressure must be built up necessarily. In an area of this space which is located downstream of the odour filter, an air outlet is envisaged by way of which a part of the air flow generated by the fan enters the space as circulating air, with a mean air velocity whose value will also be substantially larger than the above-mentioned value of 0.6 m/s.

From the German utility model No. 73 39 571, an odour destroyer for grill and cooking smoke or similar is known, particularly for chicken grills, which comprises a retaining casing with suction channel, fan and filter assembly. The filter assembly is established from a pre-filter as fat filter and a main filter as odour filter. The fan is arranged between the two filters. A throttle flap is arranged upstream of the pre-filter in the suction channel. The suctioned air or smoke volume can be set by means of the throttle flap. Moreover, the grill or cooking temperature can be set with the throttle flap because this is synchronously switched with a setting device for the grill temperature. With the throttle flap, the mean air velocity downstream of the odour filter can be controlled theoretically, even though this is not mentioned in the German utility model. In practice, however, and with the increasing closing of the throttle flap arranged upstream of the filters and of the fan, the air volume suctioned from the grill is increasingly reduced and, subsequently, the smoke collecting is also increasingly reduced.

From the DE 199 61 785 A1 a vapour removal device is known which is similar to an air collecting device of the type mentioned above. With this known vapour removal device, a first fan is located in a chamber which has a filtered air outlet which is covered off by an odour filter. A control of the mean air velocity of the exhaust air leaving the filtered air outlet is not envisaged with this known vapour removal device and it is also not easily possible. It is more so the case that efforts are made there to improve the efficiency of the odour filter. For this purpose, a heat exchanger system is envisaged which serves the purpose of cooling the vapour exhaust air flow by means of a cooling air flow.

It is the object of this invention to establish an air collecting device and an exhaust air box of the type stated in the preamble of the claims 1 and 26, respectively, in such a way that the mean air velocity of the exhaust air leaving the air collecting device and/or the exhaust air box can be controlled in an uncomplicated manner and in such a way that neither the comfort of persons in the surrounding zone nor the air collecting is detrimentally affected.

### SUMMARY OF THE INVENTION

This object is solved according to the invention by means of an air collecting device and an exhaust air box with the features stated in the claims 1 and 26, respectively.

With the air collecting device according to the invention, a workstation where fouled air is to be held is equipped from the very beginning or can be belatedly equipped. For this purpose, the channel system with the suction opening integrated from the very beginning in the workstation in such a way that the suction opening is located at the height of a workstation, or the entire channel system can be belatedly combined with the workstation in such a way that the suction opening is positioned at the height of the workstation. In both cases, the value of the mean air velocity downstream of the outlet air opening can then be controlled in an uncomplicated manner, in particular for example it can be set to the above-mentioned low value of maximum 0.6 m/s in which an exhaust air box is positioned according to the invention downstream of the fan, wherein said exhaust air box has lateral surfaces and wherein one of the lateral surfaces has an air inlet opening with which the downstream side of the fan is connected, and wherein the other lateral sides are each formed selectively as a coverable or covered outlet air opening by an odour filter with adjustable air resistance. The size of the outlet air opening can be slightly varied in this case wherein one lateral surface, preferably several lateral surfaces of the exhaust air box are provided with outlet air openings. The desired value of the mean air velocity of the exhaust air can be finally set in such a way that, for covering off the or every outlet air opening, an odour filter with a corresponding air resistance is selected in which, for example, an odour filter material is applied with corresponding porosity and/or with corresponding layer thickness. In this way, not only the desired low value of the mean air velocity downstream of the outlet air opening is achieved, but also the filter efficiency is improved because the lower mean air velocity produces a correspondingly longer residence time of the air loaded with odour substances in the odour filter. With the invention, namely, and not as in the state of the art according to the above-mentioned German utility model where the air volume flowing to the odour filter is reduced, but instead the entire air volume is distributed over an overall substantially larger outlet air opening, through which and in combination with the odour filter the mean air velocity of the exhaust air downstream of the filter can be reduced in the desired scope.

In principle, and with the air collecting device according to the invention, it is endeavoured to make the odour filter and the outlet air opening as large as possible for that particular reason because, with its increasing size, a fan with an increasingly lower output capacity can be adopted.

Compared with the pre-filter, the extreme large-surface odour filter for the air collecting device according to the invention provides the possibility of using a fan with lower output capacity but which can nevertheless move large air volumes, for which purpose a more expensive and large high-pressure suction fan is necessary according to the state of the art.

Moreover, the filtration of odour substances demands a filter which is substantially larger than a filter for the filtration of fine and extremely fine particles such as a fat filter. And this condition also can be easily fulfilled with the air collecting device and the exhaust air box according to the invention because, for the outlet air opening and subsequently for the odour filter, a size is selected which is a multiple of the size of the pre-filter and the fat filter. The counter pressure that is built up between the fan and the odour filter with the air collecting device according to the invention is therefore less by a multiple than in the case of the aforementioned state of the art. For this reason, fouled air or vapours can be suctioned off from the location of origin with a relatively small fan. Compared to the state of the art according to the EP 1 194 721 B1, this even allows that the blowing jet stream can be dispensed with completely. Compared to the state of the art according to the EP 0 915 299 B1 this allows, at the location of origin of vapours, for example at a cooking station rectangular in top view, the suctioning of vapours at only one longitudinal side of the said cooking station.

With the air collecting device according to the invention, the exhaust air flow can be controlled in an efficient manner in such a way that, downstream of the odour filter and subsequently downstream of the outlet air opening, the value of the mean air velocity amounts to a maximum of 0.6 m/s and even lies below this under normal circumstances. This low mean air velocity of the exhaust air makes it possible to have the outlet air opening with the odour filter, instead of in a horizontal arrangement and near the floor at any random location, in a vertical arrangement instead or additionally, for example in all vertical lateral surfaces of the exhaust air box and in a distance from the location of origin of fouled air or vapours, selectable in wide limits. In addition, the maximum value of the mean air velocity of 0.6 m/s is only one example and, depending on the ambient conditions, can vary in a wide range.

As in the case of the state of the art as mentioned above, with the air collecting device according to the invention, the exhaust air is conducted into the room as circulating air. From the aspects of the energy balance, this is essentially more efficient than conducting the exhaust air to the outside atmosphere or into another room because, in this case, air would have to be continually re-supplied.

With the air collecting device according to the invention, only the suction opening has to be positioned approximately at the height of the workstation where fouled air or vapours originate. All other parts of the air collecting device which are connected to the intake opening by way of the channel system, particularly the exhaust air box and/or the suction fan located between pre-filter and odour filter, can be accommodated far away from the location of origin of fouled air or vapours at a freely selectable location. The low mean air velocity of the exhaust air downstream of the odour filter, which is obtainable with the air collecting device according to the invention, and the freely selectable location for the accommodation of the exhaust air box and/or the fan ensure that the comfort of persons at a workstation such as a food distribution equipment or in a kitchen are not detrimentally affected, neither by draft air nor by rising dust. The provision of the large odour filter with the air collecting device according to the invention is favoured from cost aspects by means of the present commercial availability of very inexpensive odour filter materials.

Advantageous embodiments of the invention form the subject-matter of the sub-claims.

If, in an embodiment of the air collecting device according to the invention, the fan on its downstream side is directly connected to the exhaust air box, then the fan moves along with the exhaust air box when selecting the best installation location for the exhaust air box.

If, in a further embodiment of the air collecting device according to the invention, the channel system has an inlet air channel connecting the fan to the exhaust air box, then only the length of the inlet air channel has to be correspondingly selected when choosing the best installation location of the exhaust air box.

If, in a further embodiment of the air collecting device and the exhaust air box according to the invention, the fan is combined with the exhaust air box, then only the exhaust air box provided with the odour filter must be accommodated at a suitable location in a space and a suitable length of the inlet air channel is required. In this case, the fan can be accommodated in a fan chamber attached to the exhaust air box or separated from the exhaust air box.

If, in a further embodiment of the air collecting device and the exhaust air box according to the invention, the or every outlet air opening is provided with a grid as an abutment for the odour filter, a corresponding odour filter can be simply mounted on this grid. With a horizontal arrangement of the same, the odour filter simply lies on the grid by means of the gravity. In addition, every odour filter is maintained in position by the exhaust air flow flowing all the way through it.

If, in a further embodiment of the air collecting device and the exhaust air box according to the invention, the or every odour filter consists of a flexible mat, capable of being placed onto the outlet air opening or is placed onto it, it is suitable in particular for use with the aforementioned embodiment which has a grid as an abutment for the odour filter.

If, in a further embodiment of the air collecting device and the exhaust air box according to the invention, the or every odour filter consists of open-cell foam which is coated with active carbon, it is most likely the presently and most conceivably inexpensive embodiment of such an odour filter which has to be replaced and disposed of only one to two times annually and which, subsequently, causes negligible costs. Preferably, and where the invention is concerned, the PORET®-Carbon-Filter is adopted as such an odour filter which can be obtained from Emmerling & Weyl GmbH & Co. Schaumstoff-KG, D-65582 Diez. The PORET®-Carbon-System is a skeleton foam with a high loading of pulverised carbon which is available in various layer thicknesses and which has a controlled porosity of 10-80 PPI (pores per inch or 4-30 pores per centimetre) as well as a selectable density of 21-30 kg/m³. Further technical data for this filter material are shown on the EMW data sheet 05/01, PORET filter foam.

If, in a further embodiment of the air collecting device and the exhaust air box according to the invention, the or every odour filter consists of a cassette which contains filter material, then the oppositely-located two large surfaces of the cassette are preferably grid-screened. Between the grids, a bed can be arranged consisting of zeolite in granulate form or of moulded carbon or of a pleated carbon fabric according to the data sheet “Active against gases and odours: Viledon CarboPleat and DuoPleat filter” of the manufacturer Freudenberg Vliesstoffe KG, D-69465 Weilheim, from 6/98, or even also a filter foam mat of the above-mentioned type. As the cassette is grid-screened, the outlet air opening does not require a grid as an abutment.

If, in a further embodiment of the air collecting device and the exhaust air box according to the invention, the exhaust air box is provided with a flap which can be opened for inserting and removing the odour filter, then the odour filter can be conveniently removed for replacement or maintenance purposes.

If, in a further embodiment of the air collecting device and the exhaust air box according to the invention, the exhaust air box is square-shaped, then the exhaust air box can be arranged at a suitably distant location from the part of the channel system provided with the suction opening, in the kitchen preferably in or near an lower cupboard or on or next to a suspended cupboard, and in a food distribution equipment in a dispensing counter or on a trolley with thermal equipment where vapours originate.

If, in a further embodiment of the air collecting device and the exhaust air box according to the invention, the exhaust air box is cylinder-shaped, then the exhaust air box can be mounted at a suitable place in a room, wherein again only a suitable connection to the part of the channel system having the suction opening must be provided for.

If, in a further embodiment of the air collecting device according to the invention, the channel system in the zone of the suction opening is formed as a scoop, fouled air or vapours can be specifically suctioned off at a workstation. At a kitchen workstation, in this case, the scoop is positioned next to the thermal equipment where the vapours originate, and the suction opening is envisaged in the scope at the height of the thermal equipment, and therefore reaches for example up to the surface of a cooking section applied as a thermal device.

If, in a further embodiment of the air collecting device according to the invention, the scoop is a separately formed module, the other part of the air collecting device according to the invention can be located at any random and suitable place in a room. Only an inlet air channel having a suitable length must be provided for.

If, in a further embodiment of the air collecting device according to the invention, the fan is integrated in the scoop, then only the exhaust air box equipped with the odour filter has to be located at a suitable place in a room and a suitable airflow connection between the scoop and the exhaust air box must be provided for.

If, in a further embodiment of the air collecting device according to the invention, the pre-filter in the channel system is arranged immediately next to the suction opening, then the selection of a suitable pre-filter serves to easily accomplish that the entire channel system in the interior remains free from particles and, in particular, free from fat. This facilitates considerably the cleaning of the channel system and allows a cleaning at longer time internals only.

If, in a further embodiment of the air collecting device according to the invention, the pre-filter is arranged in the scoop, the same advantages result as in the case of the previous embodiment wherein, however, the configuration of the inlet air channel adjoining the scoop additionally grants considerable freedoms. For example, it would be sufficient to provide for just one or several hoses as an inlet air channel between the scoop and the exhaust air box.

If, in a further embodiment of the air collecting device according to the invention, the pre-filter is arranged in the inlet air channel, the scoop can be simply separated from the channel system or the air collecting device can be operated without a scoop.

If, in a further embodiment of the air collecting device according to the invention, the inlet air channel consists of at least one flexible hose, the exhaust air box and the other part of the channel system of the air collecting device can be located away from one another at suitable places in a room and, nevertheless, connected with the suction opening in an uncomplicated manner.

If, in a further embodiment of the air collecting device according to the invention, the pre-filter is a fat filter and is in particular a vortex flow filter, for example a cyclone filter as manufactured by Rentschler & Reven, then 99.5% of fat entrained in the air can be separated. In addition to fat droplets, water droplets are also separated, a fact that benefits the performance capacity of the odour filter if an active carbon filter is involved in this particular case. A cyclone filter can be easily cleaned in a dish washer or in an immersion bath.

If, in a further embodiment of the air collecting device according to the invention, the pre-filter is a coarse particle filter or has a coarse particle filter, coarse fouling matter in the air such as hairs, fluffy substances or similar are kept away from the channel system. This configuration is significant in such cases where the air collecting device has to hold air that is mainly fouled with odours and not with fat.

If, in a further embodiment of the air collecting device according to the invention, the pre-filter is a filter made from fleece material, a coarse particle filter is realised in a very uncomplicated manner.

If, in a further embodiment of the air collecting device according to the invention, the inlet air channel and the exhaust air box are arranged above the scoop, then this is an arrangement which is suitable in those cases where there is no substructure possibility. Instead of near the floor, as in the state of the art, in this particular case the outlet air opening with the odour filter can be arranged above the location of origin of the vapours in a kitchen or food distribution equipment without affecting the comfort of persons as a result of the exhaust air. The low exhaust air velocity downstream of the odour filter with the air collecting device according to the invention makes this possible. In this case also, the suction opening is positioned near the location of origin of the vapours, as in the state of the art described above, therefore in a kitchen or food distribution equipment at the height of the location of origin of the vapours.

If, in a further embodiment of the air collecting device according to the invention, at least one lateral surface of the exhaust air box facing towards the upstream side of the suction opening is formed as an outlet air opening coverable by the odour filter or covered by the odour filter, the exhaust air box can be installed as a conventional air or vapour exhaust hood above the workstation.

However, it is different to the conventional air and vapour exhaust hood in that it serves the purpose of discharging exhaust air which does not disturb the personnel at the workstation and which is suctioned in again immediately by way of the suction opening of the air collecting device. In this way, fouled air can be subjected to several cleaning operations in succession before it finally accesses the surrounding space as circulating air, and a suction fan can be installed with an even lower output capacity.

If, in a further embodiment of the air collecting device according to the invention, at least one lateral surface, facing towards the scoop, of a hood connected to the upstream side of the exhaust air box is provided with an outlet air opening covered by an odour filter, an already existing vapour exhaust hood can be converted locally into an exhaust air box which is connected to the exhaust air box of the vapour collecting device according to the invention, or can be applied instead of same.

### BRIEF DESCRIPTION OF THE DRAWINGS

Embodiment examples of the invention are described as follows in greater detail with reference to the attached drawings. The drawings show the following:

FIG. 1 in rear view, a mobile food distribution equipment with a food cooking apparatus and with a first embodiment of an air collecting device, according to the invention, formed as a vapour collecting device,

FIG. 2 the food distribution equipment according to FIG. 1 in side view,

FIG. 3 the food distribution equipment according to FIG. 1 in front view.

FIG. 4 the food distribution equipment according to FIG. 1, in top view,

FIG. 5 as a detail in a more elaborate illustration, a part of the food distribution equipment according to FIG. 2,

FIG. 6 a modified embodiment of the applicable exhaust air box, in side view, of an air collecting device, according to the invention, formed as a vapour collecting device,

FIG. 7 the exhaust air box according to FIG. 6 in top view,

FIG. 8 the exhaust air box according to FIG. 6 in front view,

FIG. 9 in side view and partially in cross-section, a stationary food distribution equipment with a food cooking apparatus and with a second embodiment of an air collecting device, according to the invention, formed as a vapour collecting device,

FIG. 10 in side view and partially in cross-section, a stationary food distribution equipment with a food cooking apparatus and with a third embodiment of an air collecting device, according to the invention, formed as a vapour collecting device,

FIG. 11 in perspective illustration, a fourth embodiment of an air collecting device, according to the invention, formed as a vapour collecting device which is suitable for use in a kitchen or in a food distribution equipment,

FIG. 12 as a detail of a fifth embodiment of an air collecting device, according to the invention, formed as a vapour collecting device, a cylindrically formed exhaust air box of same in side view,

FIG. 13 the exhaust air box according to FIG. 12 in a partial longitudinal sectional view,

FIG. 14 in side view and partially in section, a mobile food distribution equipment with a food cooking apparatus and with a sixth embodiment of an air collecting device, according to the invention, formed as a vapour collecting device,

FIG. 15 in front view, a kitchen unit with a food cooking apparatus and with a seventh embodiment of an air collecting device, according to the invention, formed as a vapour collecting device,

FIG. 16 in side view, the kitchen unit according to FIG. 15,

FIG. 17 in side view, a work table with an eighth embodiment of the air collecting device according to the invention and

FIG. 18 the air collecting device according to FIG. 17 in front view.

### DETAILED DESCRIPTION OF THE PREFERRED EMBODIMENTS OF THE PRESENT INVENTION

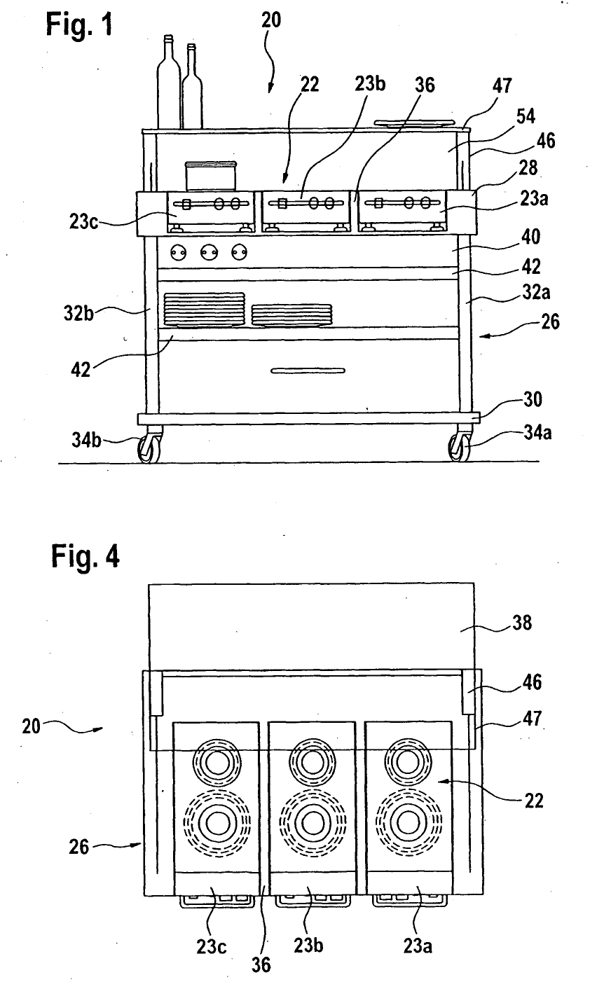

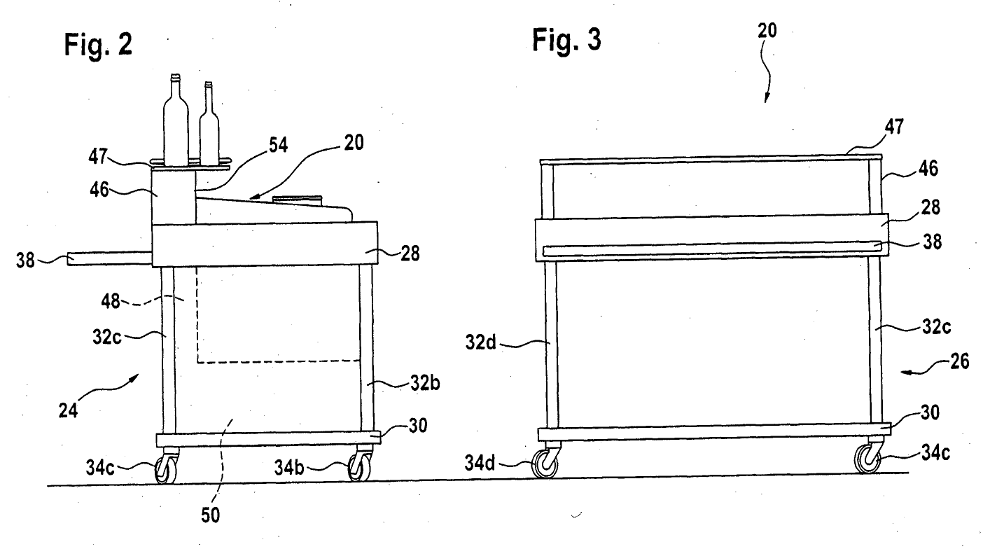

FIGS. 1-4 show a mobile food distribution equipment, generally designated 20, with a food cooking apparatus, generally designated 22, and with a first embodiment of a vapour collecting device, generally designated 24, according to the invention, in rear view, side view, front view and top view, respectively. The mobile food distribution equipment 20 is accommodated on a trolley 26 which has an upper frame 28 and a lower frame 30 which are connected up together by means of four vertical columns 32a-32d, and supported on the floor by means of four caster wheels 34a-34d. In the upper frame 28 a niche 36 is formed which, as shown in FIG. 1, is open on the rear side of the trolley 26. The food cooking apparatus 22 is located in the niche 36 and consists of three thermal devices 23a-23c arranged next to one another for keeping food warm and/or for cooking the food. According to the illustration in the FIGS. 2-4, the food distribution equipment 20 has a tray slide 38 on its front or customers side, and this said slide is secured to the upper frame 28. The lower frame 30 in the shown embodiment example is a rectangular frame welded from square pipe. Below the open side of the niche 36 a socket strip 40 is secured which extends between the columns 32a and 32b with three sockets implied in FIG. 1 for the electric power connection of the three thermal devices 23a, 23b and 23c. An intermediate bottom 42 serves for placing down plates/dishes or similar.

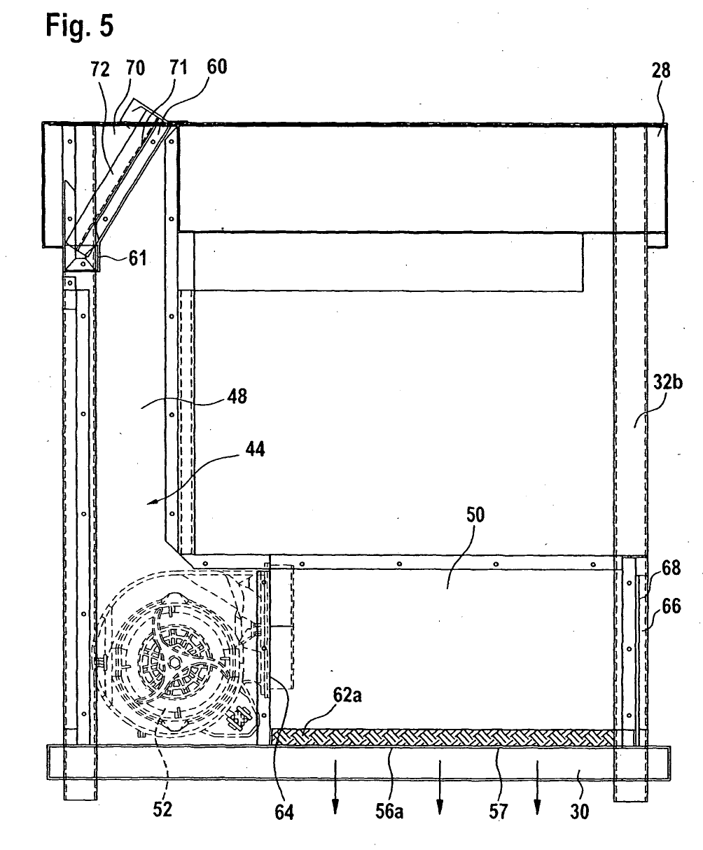

The vapour collecting device 24 comprises a channel system 44, consisting of a scoop 46, an inlet air channel 48 and an exhaust air box 50 which are in opposite arrangement in airflow connection to one another. A fan 52 is arranged in the channel system in such a way, for example, as shown in FIG. 5, and additional reference is now made to this.

FIG. 5 shows, as a detail in a more elaborate illustration, a part of the food distribution equipment 20 according to FIG. 2. The scoop 46, the intermediate bottom 42 and the caster wheels 34a-34d have been left out from FIG. 5 for the purpose of simplifying the illustration of the channel system 44.

The channel system 44 leads from a suction opening 54 provided in the scoop 46, or from an air inlet opening 70 forming the suction opening, to at least one outlet air opening 56a provided in the exhaust air box 50. The suction opening 54 and/or the air inlet opening 70 is positioned on the height of the thermal devices 23a-23c, therefore at that location where vapours originate when keeping food warm or when cooking food or similar. With the vapour collecting device 24 according to FIG. 1 to 5, the fan 52 is arranged in the inlet air channel 48 at the downstream end of same. The fan 52, on its downstream side, is connected directly to the exhaust air box 50. The fan 52, with this embodiment and with the further embodiments described further below of the vapour collecting device 24 according to the invention, is preferably a double-sided suctioning AC radial fan of the manufacturer ebm-papst Mulfingen GmbH & Co. KG, D-74673 Mulfingen, for example the type D2E 146-HT760-01. Further details on this fan can be found on pages 84 and 85 of the catalogue “ebm-papst radial fans and ventilators, axial ventilators” from the year 2004. The fan 52 has the purpose of suctioning off the air soaked with vapours at the location of origin above the food cooking apparatus 22 and to convey it to the outlet air opening 56a, so that the air on its route through a filter device is cleaned.

The filter device is arranged in the channel system 44 and has at least one fat filter 60 as a pre-filter and at least one odour filter 62a as a main filter. In FIG. 5, the channel system 44 as from the fan 52 is formed as the already mentioned exhaust air box 50 which is square-shaped in this embodiment example, meaning, it has six lateral surfaces. Every lateral surface can be formed as an outlet air opening wherein every outlet air opening can be selected as large as possible, as allowed by the stability bracing of the square-shaped exhaust air box 50. In FIG. 5, that particular lateral surface of the exhaust air box 50, to which the fan 52 is connected, is provided merely with an air inflow opening 64, therefore with no outlet air opening. In a flap 66, which closes off an access opening 68 of the exhaust air box 50 where said opening 68 is accessible from the rear side of the food distribution equipment 20, an outlet air opening 56d is formed.

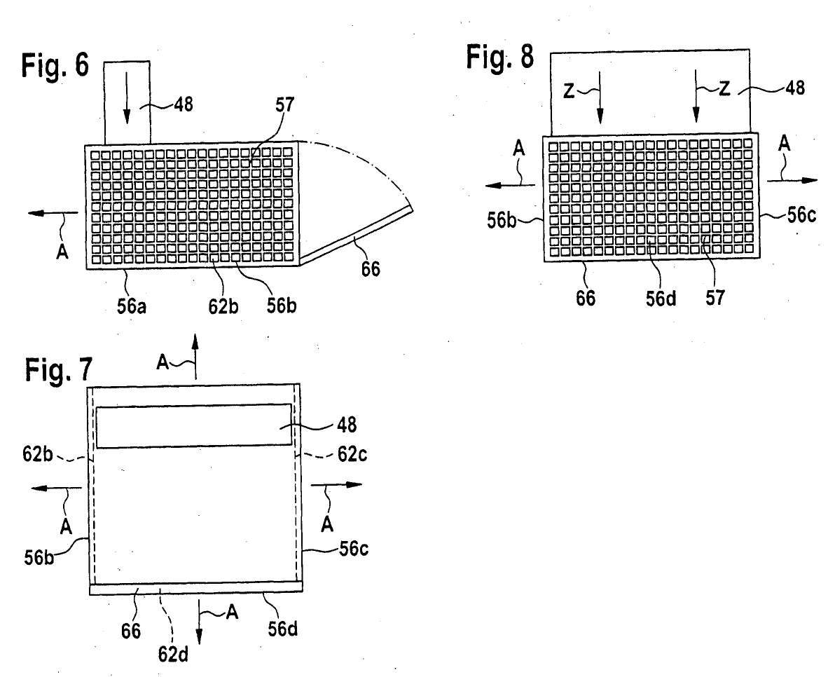

In the FIGS. 6-8, to which a more detailed reference is made in the following, an exhaust air box 50 is shown in side view, top view and front view, respectively, applicable for a modified embodiment with a vapour collecting device 24 according to the invention.

These Figures also show that the two vertical lateral walls of the exhaust air box 50 are formed as outlet air openings 56b, 56c. Each of the outlet air openings 56a-56d is covered off with an odour filter 62a-62d. The entire size of the outlet air openings 56a-56d and the odour filters 62a-62d is selected in such a way and in combination with the air resistance of the odour filters, determined by their porosity and/or their thickness, that, with a pre-specified volume flow of the outlet air A which is produced by the fan 52, a value of the mean air velocity results downstream of the outlet air openings and the odour filters, and the comfort of persons in the area surrounding the food distribution equipment 20 as well as the filter efficiency are not detrimentally affected by this said value, as has been explained above in this description.

Flexible foam mats coated with active carbon powder are preferably applied as odour filters 62a-62d and are placed onto the outlet air openings 56a-56d. For this case, each outlet air opening is provided with a grid 57 as an abutment for the odour filter. Instead of this, each odour filter can consist of a cassette which contains the filter material and is provided with a grid 57 on its front side and also on its rear side. In this case, each cassette has the same structure as the flap 66 according to the FIGS. 6 and 8.

With the vapour collecting device according to the FIGS. 1-4, the channel system 44 in the zone of the suction opening 54 is formed as the scoop 46. The scoop 54 is a specially formed module that is mounted over the air inlet opening 70 of the inlet air channel 48 and onto the upper frame 28 in such a way as illustrated in the FIGS. 1-4. The upper side of the scoop 46 in the illustrated example is formed as a side rest 47. The fat filter is arranged in the channel system 44 immediately next to the suction opening 54 in the upstream end of the inlet air channel 48 in the immediate vicinity of the air inlet opening 70. A fat retaining sump 61 is arranged below the fat filter 60. In the embodiment example described here, either a filter made of fleece material or made of a metal knitted element, or as implied in FIG. 5 an agglomerator 71 and a further fat filter 72, are subsequently arranged to the fat filter 60. If, as in this case, the agglomerator 71 and the further fat filter 72 are subsequently arranged to the fat filter 60, the moisture can be practically 100% separated from the air soaked with vapours before this air makes its way into the channel system 44 downstream of the fat filters 60, 72. A cyclone filter installed as a fat filter 60 is, for example, capable of separating particles which have a size of 5 μm or larger. Extremely fine water droplets can have a size below 5 μm. These are transformed by the agglomerator 71, a metal knitted element, into larger drops and then separated by the further filter fat 72.

In the embodiment example of the exhaust air box 50 as shown in the FIGS. 6-8, the inlet air channel 48 enters directly into the upper lateral surface of the exhaust air box. With this embodiment example, the non-illustrated fan is arranged in the non-visible and in the further upstream part of the channel system 44, for example in the scoop 46 also not shown here.

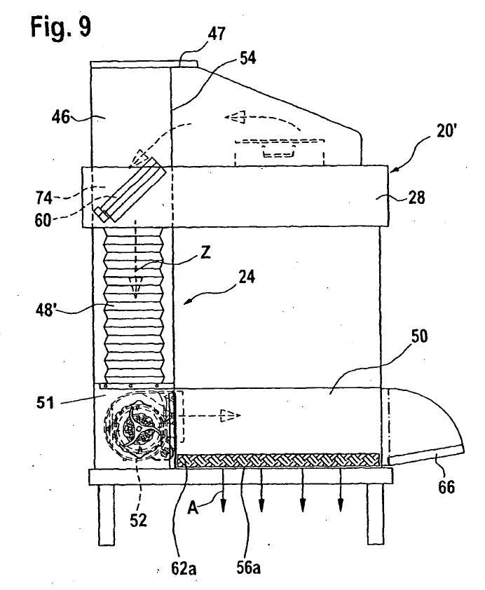

FIG. 9 shows, in a side view and partially in section, a stationary food distribution equipment 20′ with a food cooking apparatus 22 and with a second embodiment of the vapour collecting device 24 according to the invention. As in the case of the first embodiment, the fan 52 is connected on its downstream side directly with the exhaust air box 50 which can have here the same structure as the first embodiment, therefore as in the illustration in FIG. 5. The difference compared to the first embodiment is that the inlet air channel 48′ is provided which consists of a flexible hose and is connected to a fan chamber 51 containing the fan 52, and that the fat filter 60 is arranged in a recess 74 in the upper frame 28 immediately below the scoop 46.

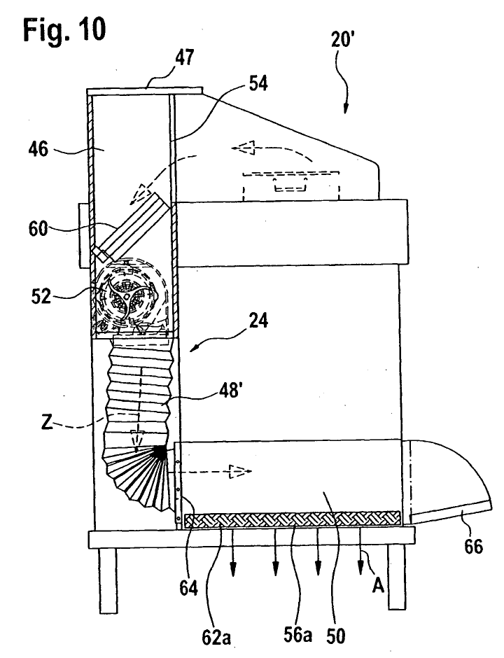

FIG. 10 shows, in a side view and partially in section, a stationary food distribution equipment 20′ with a food cooking apparatus 22 with a third embodiment of the vapour collecting device 24 according to the invention, which is different to the second embodiment according to FIG. 9, in that the fat filter 60 as well as the fan 52 immediately downstream of this filter are arranged in the scoop 46, in an area which is located below the suction opening 54. The scoop 46 is connected with the air inflow opening 64 of the exhaust air box 50 by means of an exhaust air channel 48′ which consists of a flexible hose.

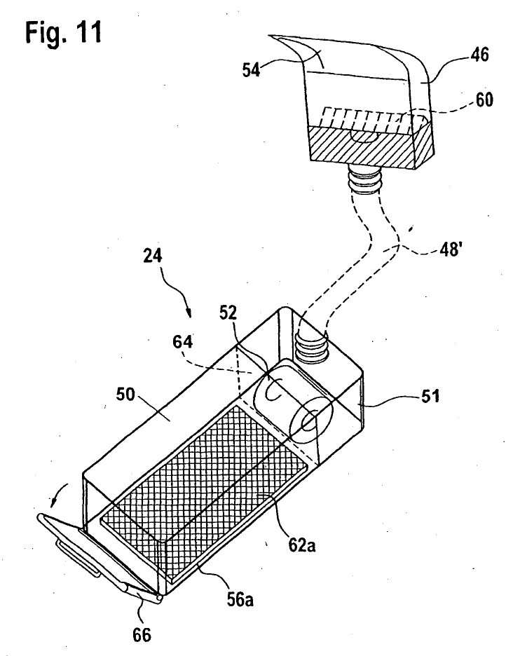

FIG. 11 is a perspective and schematic illustration of a fourth embodiment of the vapour collecting device 24 according to the invention which is suitable for use in a kitchen or in a food distribution equipment. The fat filter 60 is integrated in the scoop 46. The fan 52, which is combined with the exhaust air box 50, is accommodated in a fan chamber 51 attached to the exhaust air box 50 or partitioned off from the exhaust air box 50. The scoop 46 and the fan chamber 51 are connected by means of an inlet air channel 48′ which is formed by a flexible hose. Only one lateral surface of the exhaust air box 50 is shown, namely the bottom or lower surface provided with an outlet air opening 56a and an odour filter 62a. However, the vertical lateral surfaces of the exhaust air box and the flap 66 can each be equipped with an outlet air opening and an odour filter, except for the lateral surface which has the air inflow opening 64.

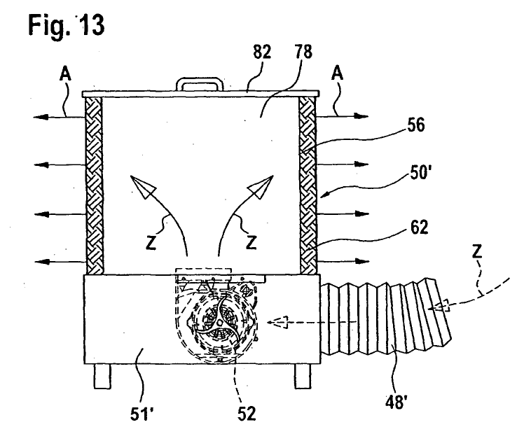

In the very simplified illustration in FIG. 11 the air outlet channel, on the downstream side of the fan 52 which is connected to the air inflow opening 64, is not shown. The air outlet channel on the downstream side of the fan 52 is implied with dashed lines in FIGS. 9 and 13. The two axial facial sides of the fan 52 form its air inlet openings.

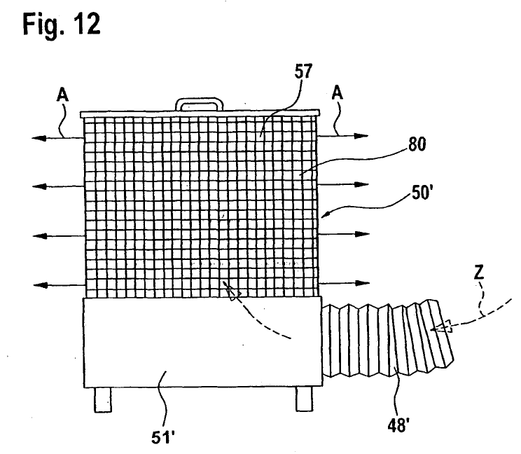

The FIGS. 12 and 13 show as a detail a fifth embodiment of the vapour collecting device 24, according to the invention, a cylinder-shaped exhaust air box 50′ of same in side view and in a partial longitudinal sectional view, respectively. The fan 52 is arranged in a lower chamber or fan chamber 51′ of the exhaust air box 50′. The exhaust air box 50′ is connected to the remaining channel system, not shown in the FIGS. 12 and 13, by way of the fan 52 in the fan chamber 51′ and an inlet air channel 48′ which is formed as a flexible hose and connected to the fan chamber 51′. An upper chamber 78 is formed on its entire shell surface as a grid-screened outlet air opening 80 which is covered off on the inner side of the grid 57 with an odour filter 62. The upper chamber 78 is closed off with a removable cover or flap 82, both of which can be locked in the shut position.

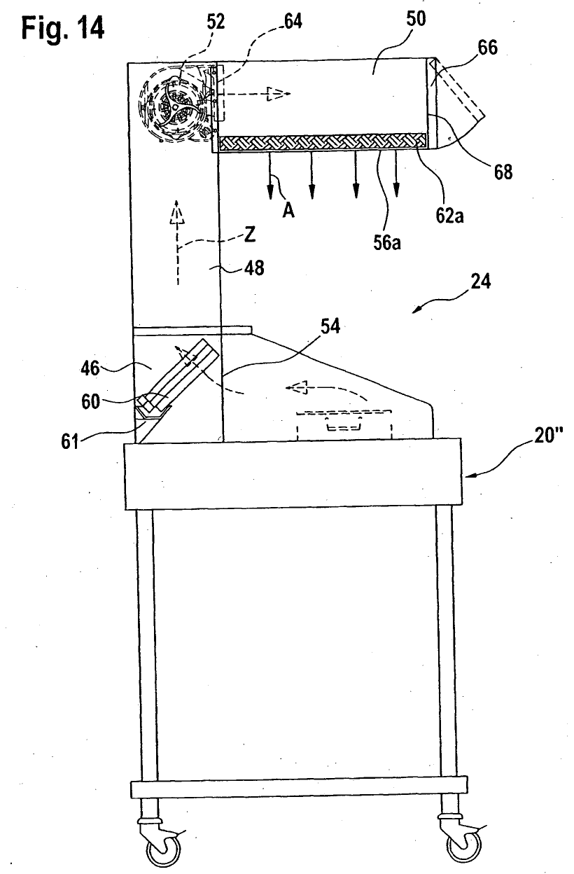

FIG. 14 shows in side view and partially in section a mobile food distribution equipment, generally designated 20″, with a food cooking apparatus (not visible in FIG. 14) and with a sixth embodiment of the vapour collecting device 24 according to the invention. An inlet air channel 48 than can consist here of two branches, spaced apart by the length of the trolley, leading to the exhaust air box 50 arranged above the scoop 46, contains the fan 52 connected directly to the exhaust air box 50. The exhaust air box 50 and the fan 52 have, otherwise, the same structure as the second embodiment of the vapour collecting device 24 as shown in FIG. 9. In the embodiment according to FIG. 14, the fat filter 60 and the fat retaining sump 61 are arranged in the scoop 46. In the illustration in FIG. 14, the lateral surface of the exhaust air box 50 facing downwards, meaning facing towards the upstream side of the suction opening 54, is shown as a outlet air opening 56a covered off by the odour filter 62a. As in the case of the exhaust air box 50 according to the FIG. 5-8, however, the vertical lateral surfaces and the upper lateral surface of the square-shaped exhaust air box 50 according to FIG. 14 can be formed in each case as an outlet air opening which is covered off by an odour filter. Likewise and as in FIG. 8, the flap 66 can be provided with an odour filter.

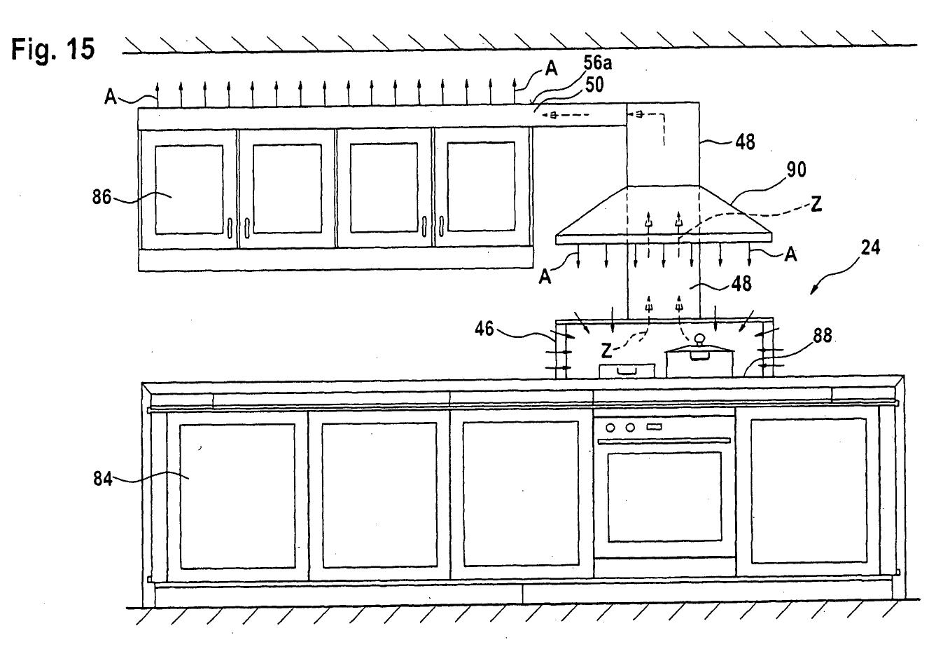

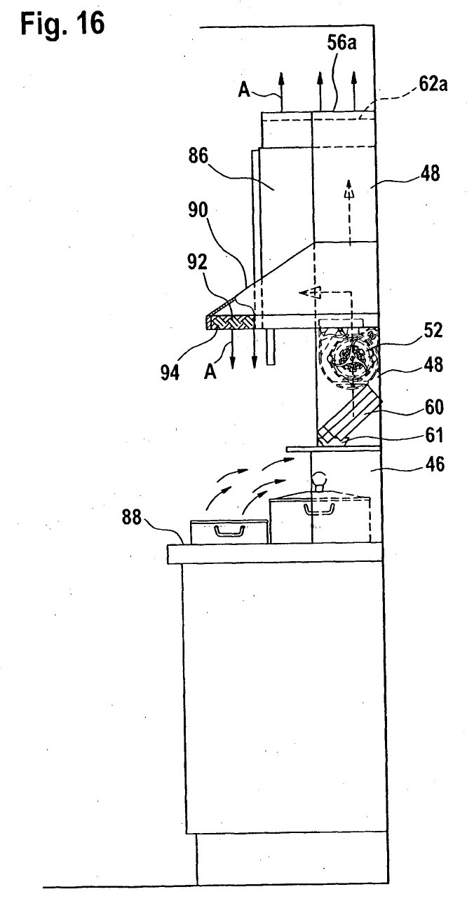

As in the case of the embodiment of the vapour collecting device 24, the size of the outlet air openings is selected in such a way that, in combination with the applied odour filters, the desired low maximum value of the mean air velocity of the outlet air A results. In operation, the fan 52 suctions the air soaked with vapours at the location of origin of the vapours by way of the suction opening 54 into the scoop 46 which is flow-connected to the inlet air channel 48 arranged above it. In the fat filter 60, the suctioned air is liberated from particles such as fat or water droplets and flows as inlet air Z to the fan 52, from where the inlet air is conveyed into the exhaust air box 50 and is discharged as outlet air A through the odour filter(s). The outlet air A leaving the odour filter 56a and flowing in the direction of the food cooking apparatus is again suctioned back into the scoop 46 in order to flow through the channel system again as inlet air Z, wherein it is cleaned again in the process. This embodiment is suitable not only for use on a trolley, as implied in FIG. 14, but also as a mounted unit on a kitchen device that is applied for food cooking purposes. The exhaust air box 50 in this case assumes the position where a vapour exhaust hood is otherwise located. However, contrary to this, it supplies the outlet air A which supports the process of the vapour suctioning from the location of origin of the vapours at the height of the food cooking apparatus. Such a vapour collecting device, however, can also be used in combination with an existing vapour exhaust hood, wherein the latter is converted into an outlet air hood. Such a case is shown in FIGS. 15 and 16 which are explained as follows.

The FIGS. 15 and 16 show in the front view and in the side view, respectively, a kitchen unit with a food cooking apparatus and a seventh embodiment of the vapour collecting device 24 according to the invention. The kitchen unit consists of a row of lower cupboards 84 and of a row of suspended cupboards 86. At one end of the line of lower cupboards 84, a cooking section 88 serving as a food cooking apparatus is installed, where vapours originate when in use. The scoop 46, as shown, is mounted around the cooking section 88 and connected to a hood 90 by means of the inlet air channel 48 in which the fat filter 60 and the fan 52 are arranged according to the illustration in FIG. 16. The air inlet channel 48 is extended upwards beyond the hood 90 and connected to an extended exhaust air box 50 which discharges the outlet air A upwards by way of its outlet air opening 56a which is directed upwards and covered off by an odour filter 62a. The lower lateral surface, facing the scoop 46, of the hood 90 connected to the upstream side of the exhaust air box 50 is provided with an outlet air opening 92 covered off by an odour filter 94, and by way of this said opening the outlet air A is discharged downwards in the direction towards the cooking section 88.

As in the case of the sixth embodiment of the vapour collecting device 24 as shown in FIG. 14, the vapour collecting device is advantageously supported in such a way that neither the comfort for persons in the ambient space nor the filter efficiency are detrimentally affected. This embodiment not only enables the uncomplicated selection of large-surface outlet air openings and, in combination with corresponding odour filters, the attainment of the desired low mean air velocity of the outlet air A, but even an improvement of the efficiency of the vapour collecting device and the filter unit.

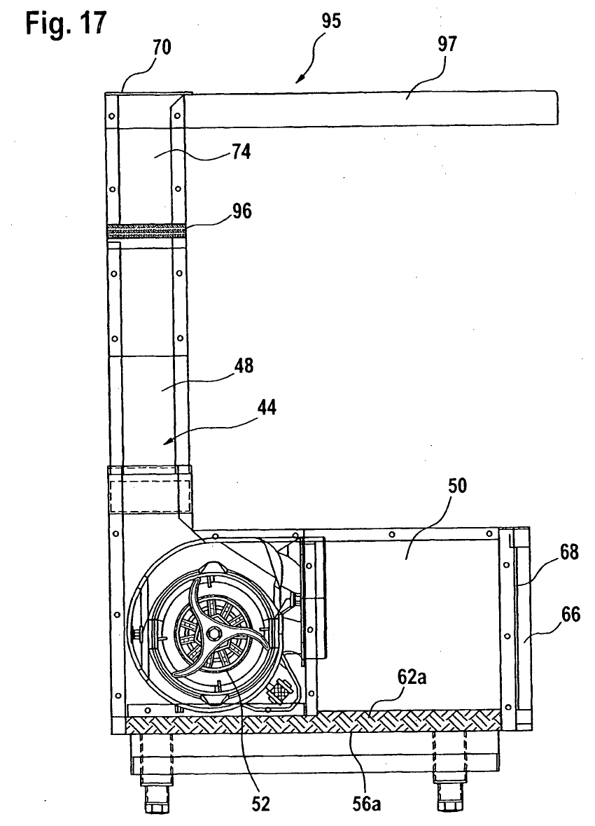

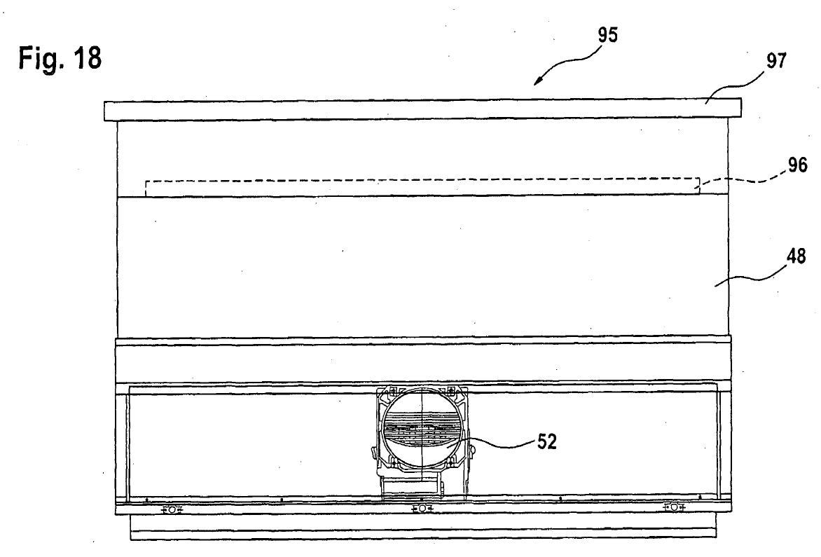

FIG. 17 shows in side view a working table, generally designated 95, with an eighth embodiment of an air collecting device according to the invention. FIG. 18 shows the air collecting device according to FIG. 17 in front view. FIG. 17 shows the air collecting device in the same illustration as for the vapour collecting device 24 in FIG. 5. In FIG. 17, the same parts as in FIG. 5 are identified with the same reference numbers and are not described here once again.

The working table 95 has a table panel 97 above, over whose rear longitudinal side the recess 74 with the air inlet opening 70 extends. In the recess 74, a coarse particle filter 96 is arranged instead of the fat filters 60, 72 as in the embodiment according to FIG. 5. This said coarse filter is preferably a filter made from fleece material. The working table 95 can be used for purposes which are named in the introduction to this description, for example for air purification and particularly odour elimination at a workstation in a workshop, a laboratory or in an anatomic or legal medicine institute.

Finally, reference is made at this point to the fact that the considerable size of the square-shaped exhaust air box 50 according to the invention makes possible the situation where, for example, only its bottom is provided with an outlet air opening 56a and this opening is covered off with an odour filter 62a, in order to obtain a sufficient reduction of the mean air velocity of the outlet air coming out of the exhaust air box. The two vertical lateral surfaces and the horizontal upper lateral surface of the exhaust air box 50 can be, accordingly, adhesively covered over on the inside with sound insulation material, so that the comfort of persons in the ambient space of a food distribution equipment 20 or of a work table 95 is also not affected by the disturbing noise of the fan 52 or the outlet air flow.

What is claimed is:

1-34. (canceled)

35. An air collecting device, in particular a vapour collecting device for kitchens and food distribution equipment, for collecting air loaded at least with odours or vapours at a workstation, in particular a workstation equipped with thermal equipment, said device comprising:
a channel system that leads from a suction opening to at least one outlet air opening;
a suction fan arranged in the channel system;
a filter device arranged in the channel system with at least one pre-filter and at least one odour filter; and
the suction opening being positionable or positioned at the height of the workstation and that the channel system downstream of the fan is formed as an exhaust air box having lateral surfaces, wherein one of the lateral surfaces has an air inflow opening with which the downstream side of the fan is connected, and wherein the other lateral sides are each formed selectively as a coverable or as a covered outlet air opening by an odour filter with adjustable air resistance.

36. The air collecting device according to claim 35, wherein the fan, on its downstream side, is directly connected to the exhaust air box.

37. The air collecting device according to claim 35, wherein the channel system has an inlet air channel connecting the fan with the exhaust air box.

38. The air collecting device according to claim 35, wherein the fan is combined with the exhaust air box.

39. The air collecting device according to claim 35, wherein at least one outlet air opening is provided with a grid as an abutment for the odour filter.

40. The air collecting device according to claim 35, wherein at least one odour filter includes a flexible mat which can be placed on or which is placed on the outlet air opening.

41. The air collecting device according to claim 40, wherein the at least one odour filter consists of open-cell foam material which is coated with active carbon.

42. The air collecting device according to claim 35, wherein at least one of the odour filters includes a cassette which contains filter material.

43. The air collecting device according to claim 35, wherein the exhaust air box is provided with a flap which can be opened for inserting or removing the at least one odour filter.

44. The air collecting device according to claim 35, wherein the exhaust air box is square-shaped.

45. The air collecting device according to claim 35, wherein the exhaust air box is cylinder-shaped.

46. The air collecting device according to claim 35, wherein the channel system is formed as a scoop in a zone of the suction opening.

47. The air collecting device according to claim 46, wherein the scoop is a specially formed module.

48. The air collecting device according to claim 46, wherein the fan is integrated in the scoop.

49. The air collecting device according to claim 35, wherein the pre-filter is arranged in the channel system immediately near the suction opening.

50. The air collecting device according to claim 49, wherein the pre-filter is integrated in the scoop.

51. The air collecting device according to claim 49, wherein the pre-filter is arranged in the inlet air channel.

52. The air collecting device according to claim 37, wherein the inlet air channel consists of at least one flexible hose.

53. The air collecting device according to claim 35, wherein the pre-filter is a fat filter.

54. The air collecting device according to claim 53, wherein the fat filter is a vortex flow filter.

55. The air collecting device according to claim 35, wherein the pre-filter includes a coarse particle filter.

56. The air collecting device according to claim 55, wherein the coarse particle filter is a filter made from fleece material.

57. The air collecting device according to the claim 37, wherein the inlet air channel and the exhaust air box are arranged above the scoop.

58. The air collecting device according to claim 57, wherein at least one lateral surface of the exhaust air box facing towards the upstream side of the suction opening is formed as an outlet air opening coverable or covered by the at least one odour filter.

59. The air collecting device according to claim 57, wherein at least one lateral surface, facing towards the scoop, of a hood connected to the upstream side of the exhaust air box is provided with an outlet air opening covered by an odour filter.

60. An exhaust air box, in particular for an air collecting device according to claim 35, includes lateral surfaces wherein one of the lateral surfaces has an air inflow opening with which the downstream side of a suction fan is connectable or is connected, and wherein the other lateral sides are each formed selectively as a coverable or covered outlet air opening by an odour filter with adjustable air resistance.

61. The exhaust air box according to claim 60, wherein the exhaust air box is combined with the suction fan.

62. The exhaust air box according to claim 60, wherein at least one of the outlet air openings is provided with a grid as an abutment for the odour filter.

63. The exhaust air box according to claim 60, wherein at least one of the odour filters consists of a flexible mat which can be placed on or which is placed on the outlet air opening.

64. The exhaust air box according to claim 63, wherein the at least one odour filter consists of open-cell foam material which is coated with active carbon.

65. The exhaust air box according to claim 60, wherein at least one of the odour filters consists of a cassette which contains filter material.

66. The exhaust air box according to claim 60, wherein the exhaust air box is provided with a flap which can be opened for inserting or removing at least one of the odour filters.

67. The exhaust air box according to claim 60, wherein the exhaust air box is square-shaped.

68. The exhaust air box according to claim 60, wherein the exhaust air box is cylinder-shaped.
